(19) United States
(12) Patent Application Publication
(10) Pub. No.: US 2017/0322679 A1
(43) Pub. Date: Nov. 9, 2017

(54) Modifying a User Interface Based Upon a User's Brain Activity and Gaze

(71) Applicant: John C. Gordon, Newcastle, WA (US)

(72) Inventor: John C. Gordon, Newcastle, WA (US)

(21) Appl. No.: 15/150,176

(22) Filed: May 9, 2016

(51) Int. Cl. G06F 3/0481; G06N 99/00; G06F 3/01

(52) U.S. Cl. CPC G06F 3/0481; G06F 3/013; G06N 99/005

(57) ABSTRACT

Technologies are described herein for modifying a user interface (“UI”) provided by a computing device based upon a user's brain activity and gaze. A machine learning classifier is trained using data that identifies the state of a UI provided by a computing device, data identifying brain activity of a user of the computing device, and data identifying the location of the user's gaze. Once trained, the classifier can select a state for the UI provided by the computing device based upon brain activity and gaze of the user. The UI can then be configured based on the selected state. An API can also expose an interface through which an operating system and programs can obtain data identifying the UI state selected by the machine learning classifier. Through the use of this data, a UI can be configured for suitability with a user's current mental state and gaze.

### BACKGROUND

Eye tracking systems (which might also be referred to herein as “gaze tracking systems”) currently exist that can measure a computer user's eye activity to determine the location at which the user's eyes are focused (which might also be referred to herein as the location of a user's “gaze”). For instance, certain eye tracking systems can determine the location at which a user's eyes are focused on a display device. This information can then be used for various purposes, such as selecting a user interface (“UI”) window that should receive UI focus (i.e. receive user input) based upon the location of the user's gaze.

Eye tracking systems such as those described above can, however, erroneously change the UI focus in certain scenarios. For example, a user might be working primarily in a first UI window that has UI focus and, therefore, be primarily looking at the first UI window. Occasionally, however, the user might momentarily gaze toward a second UI window to obtain information for use in the first UI window. In this scenario, an eye tracking system such as that described above might change the UI focus from the first UI window to the second UI window even though the user did not intent to provide input to the second UI window. Consequently, the user will then have to manually select the first UI window in order to return the focus of the UI to that window. Improperly changing the UI focus in this manner can be frustrating and time consuming for a user and cause a computing device to operate less efficiently that it would otherwise.

It is with respect to these and other considerations that the disclosure made herein is presented.

### SUMMARY

Technologies are described herein for modifying aspects of a UI provided by a computing device based upon a user's brain activity and gaze. Through an implementation of the disclosed technologies, the UI provided by a computing device can be generated or modified so that the UI is configured in a manner that is consistent with both the location of the user's gaze and the user's current mental state. For example, and without limitation, a UI window, or another type of UI object, can receive UI focus based not only upon a user's gaze, but also based upon the user's brain activity. By utilizing brain activity in addition to a user's gaze, a computing device implementing the technologies disclosed herein can more accurately select a UI window that is to receive UI focus (i.e. receive user input) and generate or customize a UI in other ways. Consequently, such a computing device can be operated more efficiently, thereby reducing the power consumption of the computing device, reducing the number of processor cycles utilized by the computing device and, potentially, extending the battery life of a computing device. Technical benefits other than those specifically identified herein can also be realized through an implementation of the disclosed technologies.

According to one configuration disclosed herein, a machine learning classifier (which might also be referred to herein as a “machine learning model”) is trained using data that identifies the state of a UI provided by a computing device, data identifying brain activity of a user of the computing device, and data identifying the gaze of the user of the computing device. The brain activity of the user can be detected utilizing brain activity sensors such as, but not limited to, electrodes suitable for performing an electroencephalogram (“EEG”) on the user of the computing device. The gaze of the user can be detected utilizing gaze sensors (which might also be referred to herein as “eye tracking sensors”) such as, but not limited to, infrared (“IR”) emitters and sensors or visible light sensors. The machine learning classifier might also be trained using data representing other biological signals of the user of the computing device collected by one or more biosensors. For example, and without limitation, the user's heart rate, galvanic skin response, temperature, capillary action, pupil dilation, facial expression, and/or voice signals can also be utilized to train the machine learning classifier.

Once trained, the machine learning classifier can select a UI state for the UI provided by the computing device based upon the user's current brain activity, gaze, and, potentially, other biological data. For example, and without limitation, data identifying a user's brain activity can be received from brain activity sensors coupled to the computing device. Gaze data identifying the location of the user's gaze can be received from gaze sensors coupled to the computing device. The machine learning classifier can utilize the data identifying the user's brain activity and gaze to select an appropriate state for the UI provided by the computing device. The UI provided by the computing device can then be generated or configured in accordance with the selected UI state.

In some configurations, an application programming interface (“API”) exposes an interface through which an operating system and application programs executing on the computing device can obtain data identifying the UI state selected by the machine learning classifier. Through the use of this data, the operating system and application programs can modify the UI that they provide to be most suitable for the user's current mental state and gaze. Several illustrative examples of the manner in which a UI provided by a computing device, including an operating system and applications executing thereupon, can be modified based upon a user's brain activity and gaze will now be provided.

In one configuration, the size of a UI object, such as a UI window or UI control, can be modified based upon a user's brain activity and gaze. For example, and without limitation, if the user's brain activity indicates that the user is concentrating and the user's gaze indicates that their eyes are focused on a UI object, the size of the UI object might be increased. Other UI objects that the user is not currently looking at might also be decreased in size.

In another configuration, the UI object that is in focus in a UI (i.e. the window or other type of UI object currently receiving user input) can be given focus or otherwise selected based upon a user's brain activity and gaze. For example, and without limitation, if the user's brain activity indicates that the user is concentrating and the user's gaze indicates that the user's eyes are focused on a UI object, the focus of the UI might be given to the UI object. In this way, UI focus can be provided to UI windows that a user is both looking at and concentrating on. UI windows that a user is looking at but not concentrating on will not receive UI focus.

In another example configuration, a UI window can be enlarged or presented full screen by the computing device based upon a user's brain activity and gaze. For example, and without limitation, if the user's brain activity indicates a high level of concentration and the user is gazing at a single UI window, the UI window can be enlarged or presented to the user full screen, thereby allowing the user to focus more greatly on the particular window. If, on the other hand, the user is concentrating but the user's gaze is alternating between multiple windows, the UI windows will not be presented in full screen mode. If the user's brain activity subsequently diminishes, the UI window might be returned to its original (i.e. non full screen) size.

In other configurations, the layout, location, number, ordering, and/or visual attributes of UI objects can be configured or modified based upon a user's brain activity and gaze. In this regard, it is to be appreciated that the examples provided above are merely illustrative and that other aspects of a UI provided by a computing device can be modified in other ways based upon a user's brain activity and gaze in other configurations. It should also be appreciated that the subject matter described briefly above and in greater detail below can be implemented as a computer-controlled apparatus, a computer process, a computing device, or as an article of manufacture such as a computer readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computing device architecture diagram showing aspects of the configuration and operation of an illustrative computing device configured to implement the functionality disclosed herein;

FIG. 2 is a software architecture diagram illustrating aspects of one mechanism disclosed herein for training a machine learning classifier to identify a UI state based upon the current brain activity of a user and the user's gaze, according to one particular configuration;

FIG. 3 is a flow diagram showing aspects of a routine for training a machine learning classifier to identify a UI state based upon the current brain activity and gaze of a user, according to one configuration;

FIG. 4 is a flow diagram showing aspects of a routine for modifying the UI provided by a computing device based on a user's current brain activity and gaze, according to one configuration;

FIG. 5 is a schematic diagram showing an example configuration for a head mounted augmented reality display device that can be utilized to implement aspects of the various technologies disclosed herein;

FIG. 6 is a computer architecture diagram showing an illustrative computer hardware and software architecture for a computing device that is capable of implementing aspects of the technologies presented herein;

FIG. 7 is a computer system architecture and network diagram illustrating a distributed computing environment capable of implementing aspects of the technologies presented herein; and

FIG. 8 is a computer architecture diagram illustrating a computing device architecture for a mobile computing device that is capable of implementing aspects of the technologies presented herein.

### DETAILED DESCRIPTION

The following detailed description is directed to technologies for generating or modifying the UI of a computing device based upon a user's brain activity and gaze. As discussed briefly above, through an implementation of the technologies disclosed herein, the state of a UI provided by a computing device can be generated or modified based upon a user's current brain activity and gaze, thereby permitting the computing device to be operated in a more efficient manner. Technical benefits other than those specifically identified herein can also be realized through an implementation of the disclosed technologies.

While the subject matter described herein is presented in the general context of program modules that execute in conjunction with the execution of an operating system and application programs on a computing device, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations including, but not limited to, head mounted augmented reality display devices, head mounted virtual reality (“VR”) devices, hand-held computing devices, desktop or laptop computing devices, slate or tablet computing devices, server computers, multiprocessor systems, microprocessor-based or programmable consumer electronics, minicomputers, mainframe computers, smartphones, game consoles, set-top boxes, and other types of computing devices.

In the following detailed description, references are made to the accompanying drawings that form a part hereof, and which are shown by way of illustration as specific configurations or examples. Referring now to the drawings, in which like numerals represent like elements throughout the several FIGS., aspects of various technologies for modifying the UI provided by a computing device based upon the brain activity and gaze of a user of the computing device will be described.

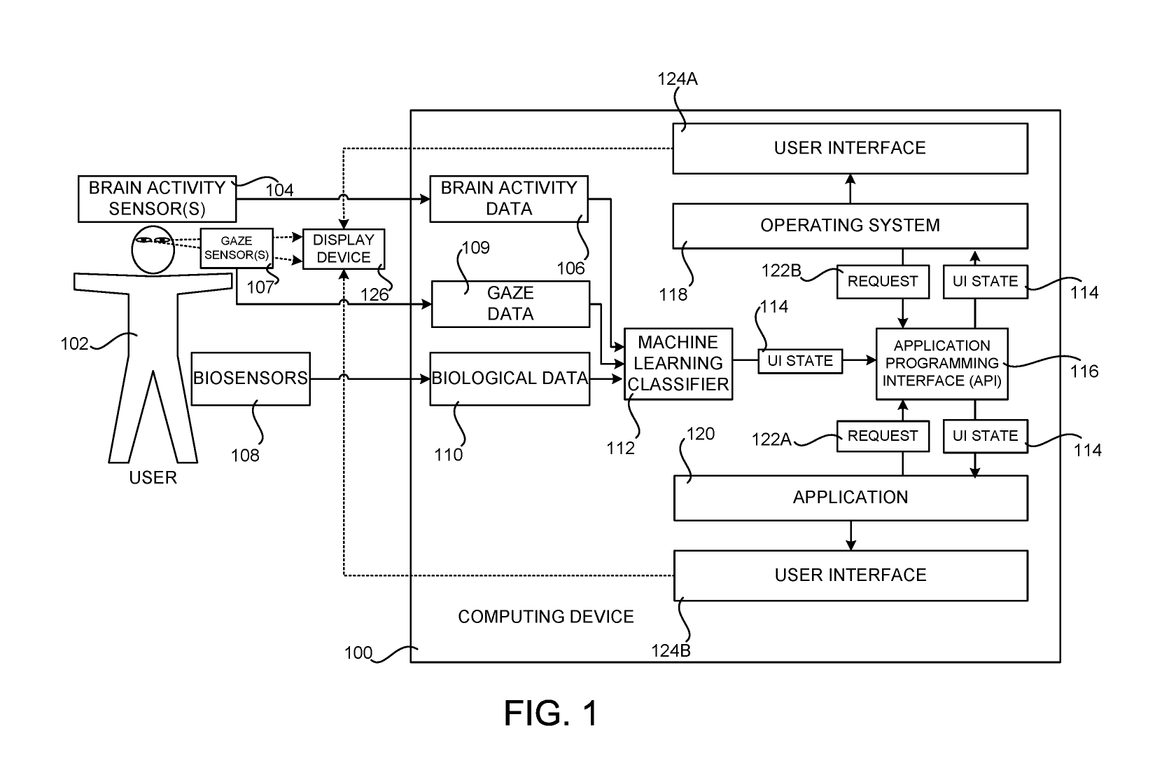

FIG. 1 is a computing device architecture diagram showing aspects of the configuration and operation of an illustrative computing device 100 configured to implement the functionality disclosed herein, according to one illustrative configuration. As shown in FIG. 1, and described briefly above, the computing device 100 is configured to modify aspects of its operation based upon the brain activity and gaze of a user 102 of the computing device 100. In order to provide this functionality, the computing device 100 is equipped with one or more brain activity sensors 104. As mentioned above, for example, the brain activity sensors 104 can be electrodes suitable for performing an EEG on the user 102 of the computing device 100. The brain activity of the user 102 measured by the brain activity sensors 104 can be represented as brain activity data 106.

As known to those skilled in the art, EEG bandwidths are separated into multiple bands, including the Alpha and Beta bands. The Alpha band is located between 8 and 15 Hz. Activity within this band can be indicative of a relaxed or reflective user. The Beta band is located between 16 and 21 Hz. Activity within this band can be indicative of a user that is actively thinking, focused, or highly concentrating. As will be described in greater detail below, the brain activity sensors 104 can detect activity in these bands, and potentially others, and generate brain activity data 106 representing the activity.

It is to be appreciated that while frequency domain analysis is traditionally used for EEG analysis in a clinical setting, it is a transform from the raw time series analog data available at each brain activity sensor 104. A given sensor 104 has some voltage that changes over time, and the changes can be evaluated in some configurations with a frequency domain transform, such as the Fourier transform, to obtain a set of frequencies and their relative amplitudes. Within the frequency domain analysis, the Alpha and Beta bands described above are useful approximations for a large range of biological activities.

Frequency domain transforms are, however, and generally speaking, approximate and lossy in real-time. Consequently, this type of transform might not be necessary or desirable in a machine learning context such as that described herein. In order to address this shortcoming, a machine learning model such as that disclosed herein can be trained to identify patterns in EEG data with higher accuracy from the raw electrode voltages than from a frequency domain transform. It is to be appreciated, therefore, that the various configurations disclosed herein can train the machine learning classifier 112 using time-series data generated by the brain activity sensors 104 directly, data that has been transformed into the frequency domain, or data representing the electrode voltages that has been transformed in another manner.

In this regard, it is also to be appreciated that the illustration of the brain activity sensors 104 shown in FIG. 1 and the discussion of EEG has been simplified for discussion purposes. A more complex arrangement of brain activity sensors 104 and related components, such as differential amplifiers for amplifying the signals provided by the brain activity sensors 104, can be utilized. These configurations are known to those skilled in the art.

As also shown in FIG. 1, the computing device 100 can be further equipped with gaze sensors 107. The gaze sensors 107 can be integrated with a display device 126 or provided externally to the display device 126. For example, an IR emitter can be optically coupled to the display device 126. The IR emitter can direct IR illumination towards the eyes of the user 102. An IR sensor, or sensors, such as an IR camera, can then measure the IR illumination reflected from the user's eyes.

A pupil position can be identified for each eye of the user 102 from the IR sensor data captured by the IR sensor, and based on a model of the eye (e.g. the Gullstrand eye model) and the pupil position, a gaze line (illustrated as dashed lines in FIG. 1) for each of the user's eyes can be determined (e.g. by software executing on the computing device 100) extending from an approximated fovea position. The location of the user's gaze in the display field of view can then be identified. An object at the point of gaze can be identified as an object of focus. When the display device 126 is translucent, as in the configurations described below, the gaze sensors 107 can be utilized to identify an object in the physical world that the user 102 is focusing on. The gaze data 109 is data that identifies the location of the user's gaze.

In one configuration, the display device 126 includes a planar waveguide that acts as part of the display and also integrates eye tracking functionality. In particular, one or more optical elements such as mirrors or gratings can be utilized that direct visible light representing an image from the planar waveguide towards the user's eye. In this configuration, a reflecting element can perform bidirectional reflection of IR light as part of the eye tracking system. IR illumination and reflections also traverse the planar waveguide for tracking the position and movement of the user's eyes, typically the user's pupil. Using such a mechanism, the location of the user's gaze when utilizing the computing device 100 can be determined. In this regard, it is to be appreciated that the eye tracking system described herein is merely illustrative and that other systems can be utilized to determine the location of a user's gaze in other configurations.

As also shown in FIG. 1, the computing device 100 can be equipped with one or more biosensors 108. The biosensors 108 are sensors capable of generating biological data 110 representative of other (i.e. other than brain activity) biological signals of the user 102 of the computing device 100. For example, and without limitation, the heart rate, galvanic skin response, temperature, capillary action, pupil dilation, facial expression, and/or voice signals of the user 102 can be measured by the biosensors 108 and represented by the biological data 110. Other types of biosensors 108 can be utilized to measure other types of bio-signals in other configurations.

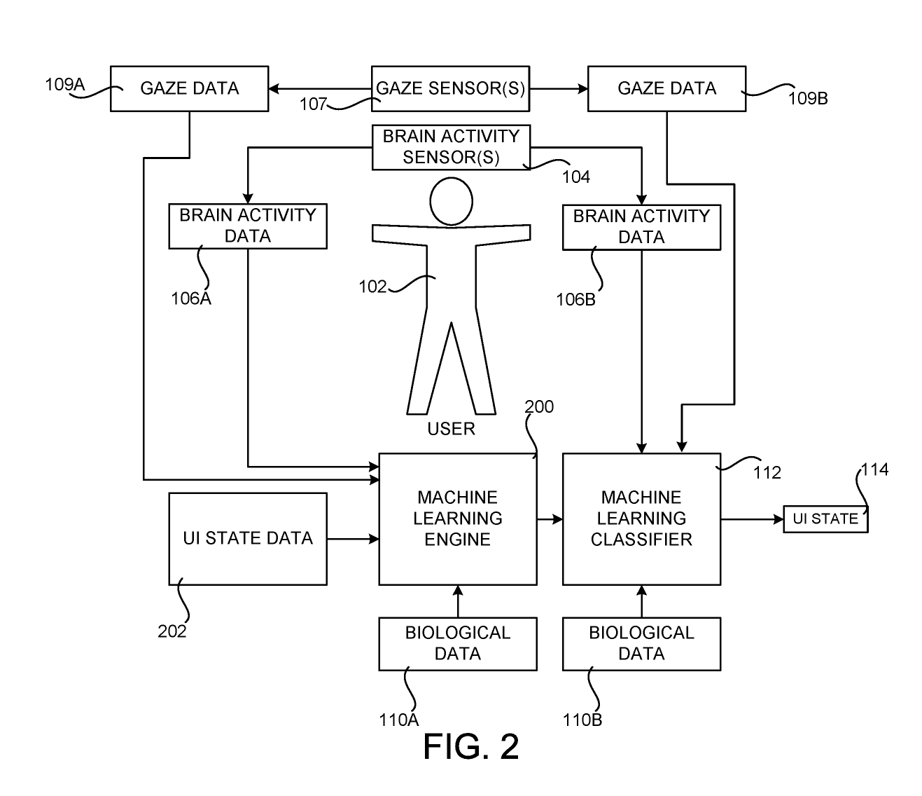

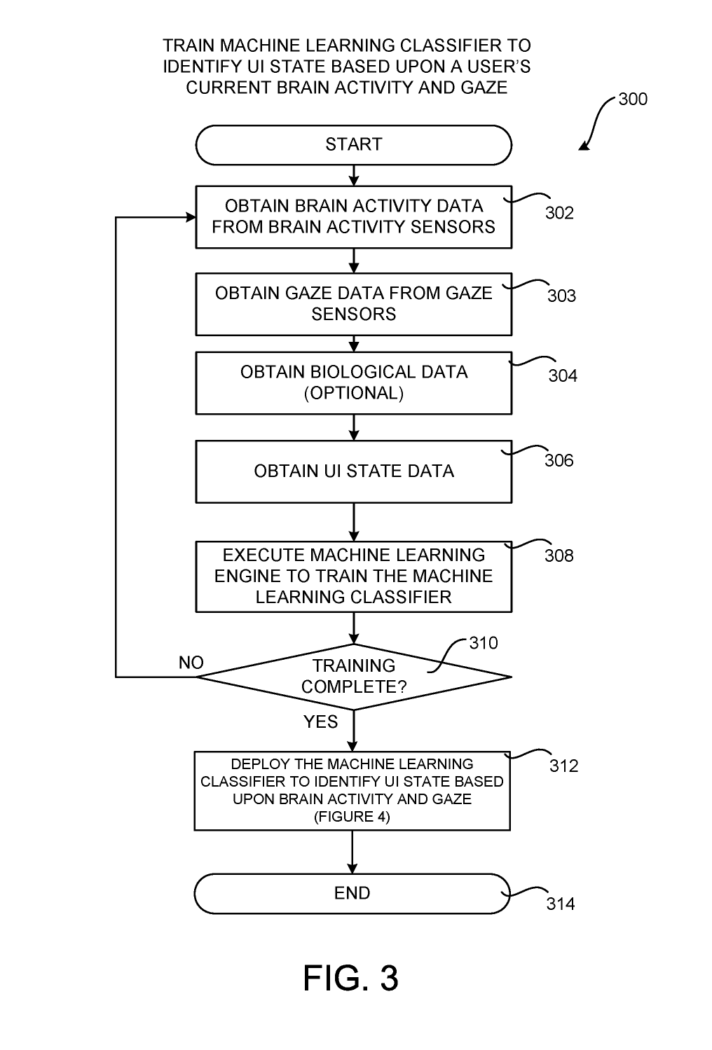

The brain activity data 106, gaze data 109 and, potentially, the biological data 110, can be provided to a machine learning classifier 112 executing on the computing device 100 in real or near-real time. As discussed in greater detail below, the machine learning classifier 112 (which might also be referred to herein as a “machine learning model”) is a classifier that can select a UI state 114 for operating the computing device 100 based upon the current brain activity and gaze, and potentially other bio-signals, of the user 102 while operating the computing device 100. Details regarding the training of the machine learning classifier 112 to select a UI state for a UI provided by the computing device 100 based upon a user's brain activity and gaze will be provided below with regard to FIGS. 2 and 3.

As also shown in FIG. 1, an API 116 is executed on the computing device 100 in some configurations for providing data identifying the selected UI state 114 to an operating system 118, an application 120, or another type of program module executing on the computing device 100. The application 120 and the operating system 118 can submit requests 122A and 122B, respectively, to the API 116 for data identifying the current UI state 114 that is to be utilized based upon the current brain activity of the user 102.

The data identifying the current UI state 114 provided by the API 116 might, for example, indicate that the user 102 is concentrating or focusing heavily on a particular UI object, such as a UI window, and that, therefore, the UI window is to be presented in a full-screen mode (i.e. presented so that it is displayed on the entirety of the display provided by the display device 126). In this regard, it is to be appreciated that the UI state 114 can be expressed in various ways. For example, and without limitation, the UI state 114 can be expressed as an instruction to the application 120 or the operating system 118 to configure or modify their UI 124B and 124A, respectively, in a particular fashion based on the user's current brain activity and gaze. For instance, the UI state 114 might indicate that UI objects, like UI windows, are to be given focus, re-sized or scaled, rearranged, or otherwise modified (e.g. modifying other visual attributes like brightness, font size, contrast, etc.) by the application 120 or the operating system 118. The UI state 114 can be expressed in other ways in other configurations.

The application 120 and the operating system 118 can receive the data identifying the selected UI state 114 from the API 116, and modify the UI 124B and 124A, respectively, based upon the specified UI state 114. For example, and without limitation, the application 120 might configure or modify UI windows, UI controls, images, or other types of UI objects that are presented to the user 102 on the display device 126. Similarly, the operating system 118 can modify aspects of the UI 124A that it presents to the user 102 on the display device 126 based on the brain activity and gaze of the user 102.

Several illustrative examples of the manner in which the UI state of a computing device, including the UI 124A provided by the operating system 118 and the UI 124B provided by an application 120 executing thereupon, respectively, can be modified based upon the brain activity and gaze of a user 102 will now be provided. As mentioned above, the examples provided below are merely illustrative. The UIs 124A and 124B can be configured or modified differently based upon the brain activity and gaze of the user 102 in other configurations.

In one configuration, the size of a UI object, such as a UI window or a UI control presented in a UI 124A or 124B, can be modified based upon a user's brain activity and gaze. For example, and without limitation, if the brain activity data 106 for the user 102 indicates that the user 102 is concentrating and the gaze data 109 indicates that the user's eyes are focused on a UI object, the size of the UI object might be increased. For instance, the size of a UI window, a UI control, an image, video, or another type of object that can be presented within a UI can be increased. Other UI objects that the user 102 is not currently looking or concentrating on might be decreased in size.

In another configuration, a UI object within a UI, such as the UI 124A or the UI 124B, that is in focus (i.e. a window or other type of UI object currently receiving user input) can be given focus or otherwise selected based upon the brain activity of the user 120 and the location of their gaze. For example, and without limitation, if the brain activity data 106 for the user 102 indicates that the user 102 is concentrating and the gaze data 109 for the user 102 indicates that the user's eyes are focused on a particular UI object, the focus of the UI 124 can be given to the UI object that the user 102 is focusing on. In this way, UI focus can be provided to UI windows (or other types of UI objects) that a user 102 is both looking at and concentrating on. UI windows that the user 102 is looking at but not concentrating on will not receive UI focus.

In another example configuration, a UI window (or another type of UI object) can be enlarged or presented full screen by the computing device 100 based upon the brain activity and gaze of the user 102. For example, and without limitation, if the brain activity data 106 for the user 102 indicates a high level of concentration and the gaze data 109 for the user 102 is gazing at a single UI window, the UI window can be enlarged or presented to full screen, thereby allowing the user 102 to focus more greatly on the particular UI window. If, on the other hand, the user 102 is concentrating but the location of the user's gaze is alternating between multiple UI windows, the UI windows will not be presented in full screen mode. If the brain activity data 106 indicates that the user's brain activity has diminished, the UI window might be returned to its original (i.e. non full screen) size.

In other configurations, the layout, location, number, or ordering of UI objects can be configured or modified based upon the brain activity and gaze of a user 102. For example, and without limitation, the layout of UI windows can be modified such as, for instance, to more prominently present UI windows that the user 102 is concentrating on and looking at. In a similar fashion, the visual attributes of a UI object such as, but not limited to, the brightness, contrast, font size, scale, or color of a UI objet can be configured or modified based upon a user's brain activity and gaze. In this regard it is to be appreciated that the examples provided above are merely illustrative and that a UI provided by the computing device 100 can be configured or modified in other ways depending upon the user's brain activity and gaze in other configurations.

FIG. 2 is a software architecture diagram illustrating aspects of one mechanism disclosed herein for training a machine learning classifier 112 to identify a UI state 114 for a UI provided by the computing device 100 based upon the current brain activity and gaze of a user 102, according to one particular configuration. In one configuration, a machine learning engine 200 is utilized to train the machine learning classifier 112 to classify the UI state 114 for a UI provided by the computing device 100 based upon the user's brain activity and gaze. In particular, the machine learning engine 200 receives brain activity data 106A generated by the brain activity sensors 104 while the user 102 is utilizing the computing device 100.

The machine learning engine 200 also receives UI state data 202 that describes the current UI state of a UI provided by the computing device 100 at the time the brain activity data 106A is received. For instance, in the examples given above the UI state data 202 might specify whether a user is viewing an UI window full screen or whether a UI window has UI focus. The UI state data 202 can define other aspects of the current state of a UI provided by the computing device 100 in other configurations.

As shown in FIG. 2, the machine learning engine 200 can also receive biological data 110A in some configurations. As discussed above, the biological data 110A describes biological signals of the user 102 other than brain activity and gaze while the user 102 is utilizing the computing device 100. In this manner, both the user's brain activity, gaze and biological signals can be correlated to various UI states.

The machine learning engine 200 can utilize various machine learning techniques to train the machine learning classifier 112. For example, and without limitation, Naïve Bayes, logistic regression, support vector machines (“SVMs”), decision trees, or combinations thereof can be utilized. Other machine learning techniques known to those skilled in the art can be utilized to train the machine learning classifier 112 using the brain activity data 106A, the gaze data 109, the UI state data 202 and, potentially, the biological data 110A.

As discussed above, once the machine learning classifier 112 has been sufficiently well trained, the machine learning classifier 112 can be utilized to identify a UI state 114 for operation of the computing device 100 based upon the brain activity data 106B and gaze data 109B of the user 102 and, potentially, the biological data 110B. As also discussed above, data identifying the selected UI state 114 can be provided to the operating system 118 or the application 120 via the API 116 in some configurations. Other mechanisms can be utilized to provide data identifying the UI state 114 to the operating system 118 and applications 120 in other configurations. Additional details regarding the training of the machine learning classifier 112 are provided below with regard to FIG. 3.

In this regard, it is to be appreciated that while a machine learning classifier 112 is utilized in some configurations, other configurations might not utilize the machine learning classifier 112. For example, and without limitation, in some configurations the UI state 114 can be determined based upon the brain activity data 106B and the gaze data 109B without regard to the user's previous behavior. For instance, as in the example configuration described above, focus can be given to a UI window that the user is looking at and concentrating on without utilizing the machine learning classifier 112. Other aspects of a UI 124 can also be modified in the manner described above without utilizing the machine learning classifier 112 in other configurations.

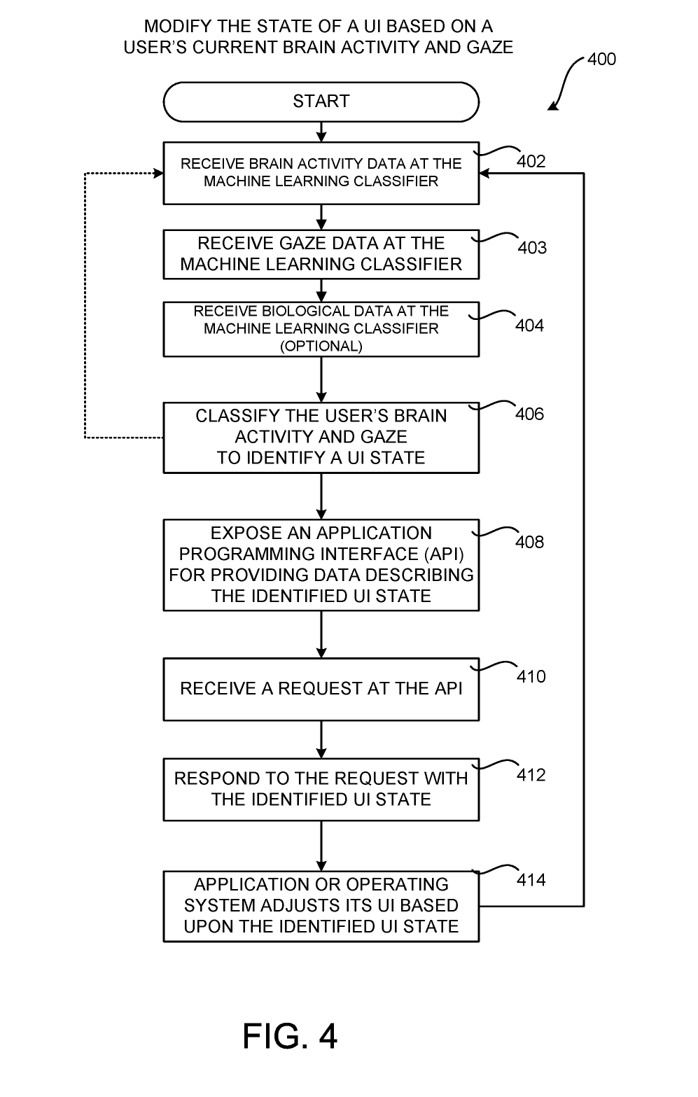

FIG. 3 is a flow diagram showing aspects of a routine 300 for training the machine learning classifier 112 to identify a UI state 114 for operating the computing device 100 based upon the current brain activity and gaze of a user 102, according to one configuration. It should be appreciated that the logical operations described herein with regard to FIGS. 3 and 4, and the other FIGS., can be implemented (1) as a sequence of computer implemented acts or program modules running on a computing device and/or (2) as interconnected machine logic circuits or circuit modules within the computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in software, in firmware, in special purpose digital logic, and any combination thereof. It should also be appreciated that more or fewer operations can be performed than shown in the FIGS. and described herein. These operations can also be performed in a different order than those described herein.

The routine 300 begins at operation 302, where the machine learning engine 200 obtains the brain activity data 106A. As discussed above with regard to FIGS. 1 and 2, the brain activity data 106A is generated by the brain activity sensors 104, and describes the brain activity of the user 102 while using the computing device 100. From operation 302, the routine 300 proceeds to operation 303, where the machine learning engine obtains the gaze data 109 As discussed above, the gaze data 109 identifies the location of the user's gaze. From operation 303, the routine 300 proceeds to operation 304.

At operation 304, the machine learning engine 200 receives the biological data 110A from the biosensors 108 in some configurations. As discussed above with regard to FIGS. 1 and 2, the biosensors 108 are sensors capable of generating biological data 110A that describes biological signals of the user 102 of the computing device 100. For example, and without limitation, the heart rate, galvanic skin response, temperature, capillary action, pupil dilation, facial expression, and/or voice signals of the user 102 can be measured by the biosensors 108 and represented by the biological data 110A. Other types of biosensors 108 can be utilized to measure other types of bio-signals and provide other types of biological data 110A in other configurations.

From operation 304, the routine 300 proceeds to operation 306, where the machine learning engine 200 obtains the UI state data 202. As discussed above with regard to FIG. 2, the UI state data 202 describes aspects of a current UI state at the time the brain activity data 106A and gaze data 109B is received. The routine 300 then proceeds from operation 306 to operation 308, where the machine learning engine 200 trains the machine learning classifier 112 using the brain activity data 106A, gaze data 109, the UI state data 202 and, in some configurations, the biological data 110A. As discussed above with regard to FIG. 2, various types of machine learning algorithms can be utilized to train the machine learning classifier 112 in different configurations. From operation 308, the routine 300 proceeds to operation 310.

At operation 310, the machine learning engine 200 determines whether training of the machine learning classifier 112 is complete. Various mechanism can be utilized to determine whether training is complete. For example, and without limitation, actual behavior of the user 102 can be compared to behavior predicted by the machine learning classifier 112 to determine whether the machine learning classifier 112 is able to predict the state of a UI used by the user 102 greater than a predefined percentage of the time. If the machine learning classifier 112 can predict the proper UI state more than the predefined percentage of the time, the training of the machine learning classifier 112 can be considered complete. Other mechanisms can also be utilized to determine whether the training of the machine learning classifier 112 is complete in other configurations.

If training of the machine learning classifier 112 is not complete, the routine 300 proceeds from operation 310 back to operation 302, where training of the machine learning classifier 112 can proceed in the manner described above. If training is complete, the routine 300 proceeds from operation 310 to operation 312, where the machine learning classifier 112 can be deployed to identify a UI state for a UI 124 provided by the computing device 100 based upon brain activity data 106B, gaze data 109 and, potentially, the biological data 110B of the user 102. The routine 300 then proceeds from operation 312 to operation 314, where it ends.

FIG. 4 is a flow diagram showing aspects of a routine 400 for configuring of modifying a UI 124 provided by the computing device 100 based on the current brain activity and gaze of a user 102, according to one configuration. The routine 400 begins at operation 402, where the machine learning classifier 112 receives current brain activity data 106B for the user 102. From operation 402, the routine 400 proceeds to operation 403.

At operation 403, the machine learning classifier 112 receives the gaze data 109B for the user 102. The routine 400 then proceeds from operation 403 to operation 404 where, in some configurations, the machine learning classifier 112 receives the biological data 110B for the user 102. The routine 400 then proceeds from operation 404 to operation 406.

At operation 406, the machine learning classifier 112 identifies a UI state 114 for a UI provided by the computing device 100 based upon the received brain activity data 106B, gaze data 109B and, in some configurations, the biological data 110B. As illustrated by the dotted line in FIG. 4, the process described with regard to operations 402, 403, 404 and 406 can be performed repeatedly in order to continually identify an appropriate UI state 114 for a UI provided by the computing device 100 based on the user's current brain activity and gaze.

At operation 408, the API 116 is exposed for providing the selected UI state 114 to the operating system 118 and the application 120. If a request 122 is received for data identifying the selected UI state 114 at operation 410, the routine 400 proceeds to operation 412 where the API 116 responds to the request with data specifying the selected UI state 114. The requesting application 120 or operating system 118 can then adjust its UI 124 based upon the identified UI state 114. Various examples of how the operating system 118 and application 128 can adjust their UI state were provided above.

From operation 414, the routine 400 proceeds back to operation 402, where the process described above can be repeated in order to continually adjust the UI state of the UI provided by the operating system 118 and application 128. As mentioned above, although a machine learning classifier 112 is utilized in the configuration illustrated in FIGS. 1-4, it is to be appreciated that the functionality disclosed herein can be implemented without the utilization of machine learning in other configurations.

It should be further appreciated that the various software components described above executing on the computing device 100 can be implemented using or in conjunction with binary executable files, dynamically linked libraries (“DLLs”), APIs, network services, script files, interpreted program code, software containers, object files, bytecode suitable for just-in-time (“JIT”) compilation, and/or other types of program code that can be executed by a processor to perform the operations described herein with regard to FIGS. 1-8. Other types of software components not specifically mentioned herein can also be utilized.

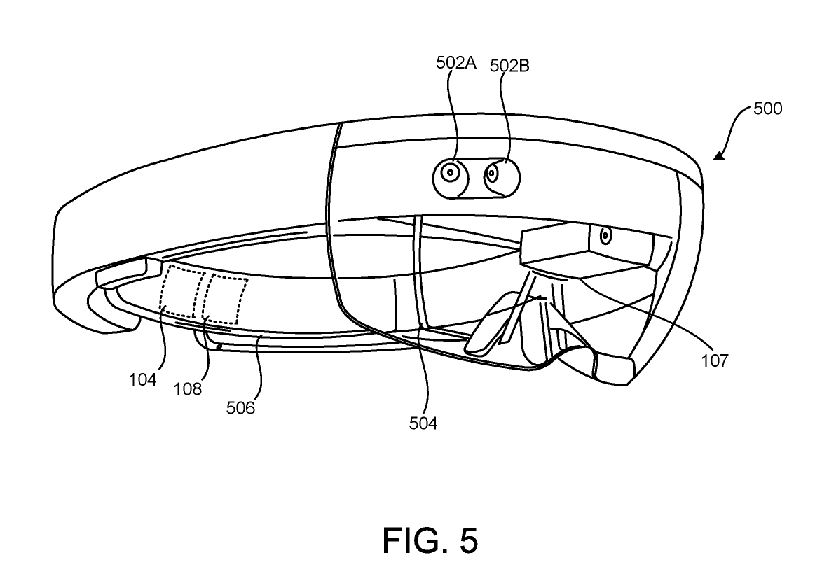

FIG. 5 is a schematic diagram showing an example of a head mounted augmented reality display device 500 that can be utilized to implement aspects of the technologies disclosed herein. As discussed briefly above, the various technologies disclosed herein can be implemented by or in conjunction with such a head mounted augmented reality display device 500 in order to modify aspects of the operation of the head mounted augmented reality display device 500 based upon the brain activity and gaze of a wearer. In order to provide this functionality, and other types of functionality, the head mounted augmented reality display device 500 can include one or more sensors 502A and 502B and a display 504. The sensors 502A and 502B can include tracking sensors including, but not limited to, depth cameras and/or sensors, inertial sensors, and optical sensors.

In some examples, as illustrated in FIG. 5, the sensors 502A and 502B are mounted on the head mounted augmented reality display device 500 in order to capture information from a first person perspective (i.e. from the perspective of the wearer of the head mounted augmented reality display device 500). In additional or alternative examples, the sensors 502 can be external to the head mounted augmented reality display device 500. In such examples, the sensors 502 can be arranged in a room (e.g., placed in various positions throughout the room) and associated with the head mounted augmented reality display device 500 in order to capture information from a third person perspective. In yet another example, the sensors 502 can be external to the head mounted augmented reality display device 500, but can be associated with one or more wearable devices configured to collect data associated with the wearer of the wearable devices.

As discussed above, the head mounted augmented reality display device 500 can also include one or more brain activity sensors 104, gaze sensors 107, and one or more biosensors 108. As also discussed above, the brain activity sensors 104 can include electrodes suitable for measuring the EEG or another type of brain activity of the wearer of the head mounted augmented reality display device 500. The gaze sensors 107 can be mounted in front of or behind the display 504 in order to measure the location of the user's gaze. As mentioned above, the gaze sensors 107 can determine the location of the user's gaze in order to determine whether the user's eyes are focused on a UI object, on a holographic object presented on the display 504, or a real-world object. Although the gaze sensors 107 are shown as being integrated with the device 500, the gaze sensors 107 can be located external to the device 500 in other configurations.

The biosensors 108 can include one or more physiological sensors for measuring a user's heart rate, breathing, skin conductance, temperature, or other type of biological signal. As shown in FIG. 5, the brain activity sensors 104 and the biosensors 108 are embedded in a headband 506 of the head mounted augmented reality display device 500 in one configuration in order to make contact with the skin of the wearer. The brain activity sensors 104 and the biosensors 108 can be located in another portion of the head mounted augmented reality display device 500 in other configurations.

The display 504 can present visual content to the wearer (e.g. the user 102) of the head mounted augmented reality display device 500. In some examples, the display 504 can present visual content to augment the wearer's view of their actual surroundings in a spatial region that occupies an area that is substantially coextensive with the wearer's actual field of vision. In other examples, the display 504 can present content to augment the wearer's surroundings to the wearer in a spatial region that occupies a lesser portion the wearer's actual field of vision. The display 504 can include a transparent display that enables the wearer to view both the visual content and the actual surroundings of the wearer simultaneously.

Transparent displays can include optical see-through displays where the user sees their actual surroundings directly, video see-through displays where the user observes their surroundings in a video image acquired from a mounted camera, and other types of transparent displays. The display 504 can present the visual content (which might be referred to herein as a “hologram”) to a user 102 such that the visual content augments the user's view of their actual surroundings within the spatial region.

The visual content provided by the head mounted augmented reality display device 500 can appear differently based on a user's perspective and/or the location of the head mounted augmented reality display device 500. For instance, the size of the presented visual content can be different based on the proximity of the user to the content. The sensors 502A and 502B can be utilized to determine the proximity of the user to real world objects and, correspondingly, to visual content presented on the display 504 by the head mounted augmented reality display device 500.

Additionally or alternatively, the shape of the content presented by the head mounted augmented reality display device 500 on the display 504 can be different based on the vantage point of the wearer and/or the head mounted augmented reality display device 500. For instance, visual content presented on the display 504 can have one shape when the wearer of the head mounted augmented reality display device 500 is looking at the content straight on, but might have a different shape when the wearer is looking at the content from the side. As discussed above, the visual content presented on the display 504 can also be selected or modified based upon the wearer's brain activity and gaze.

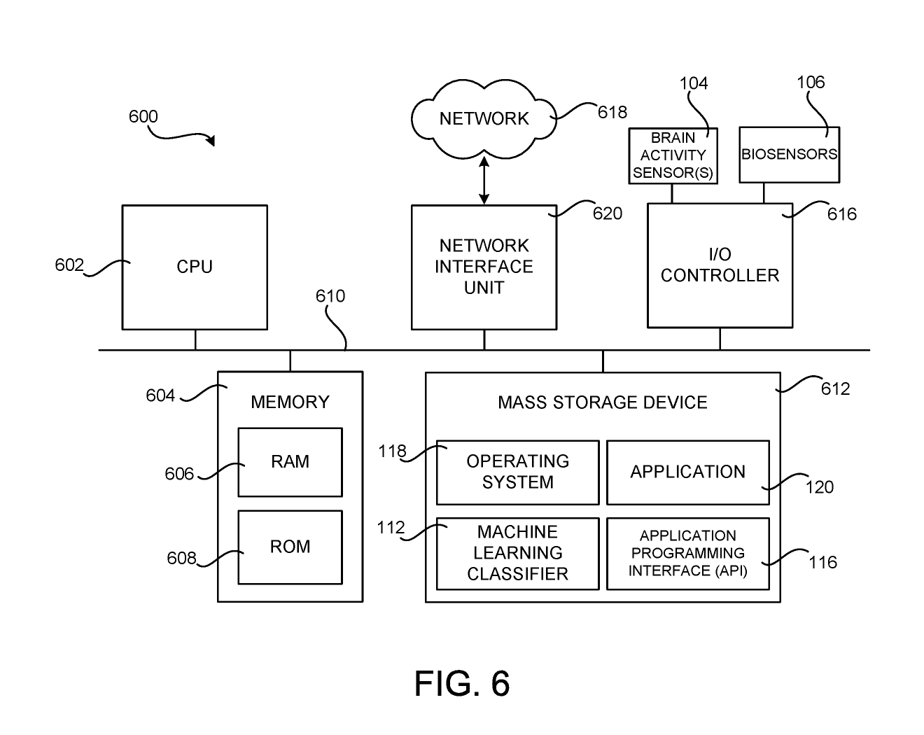

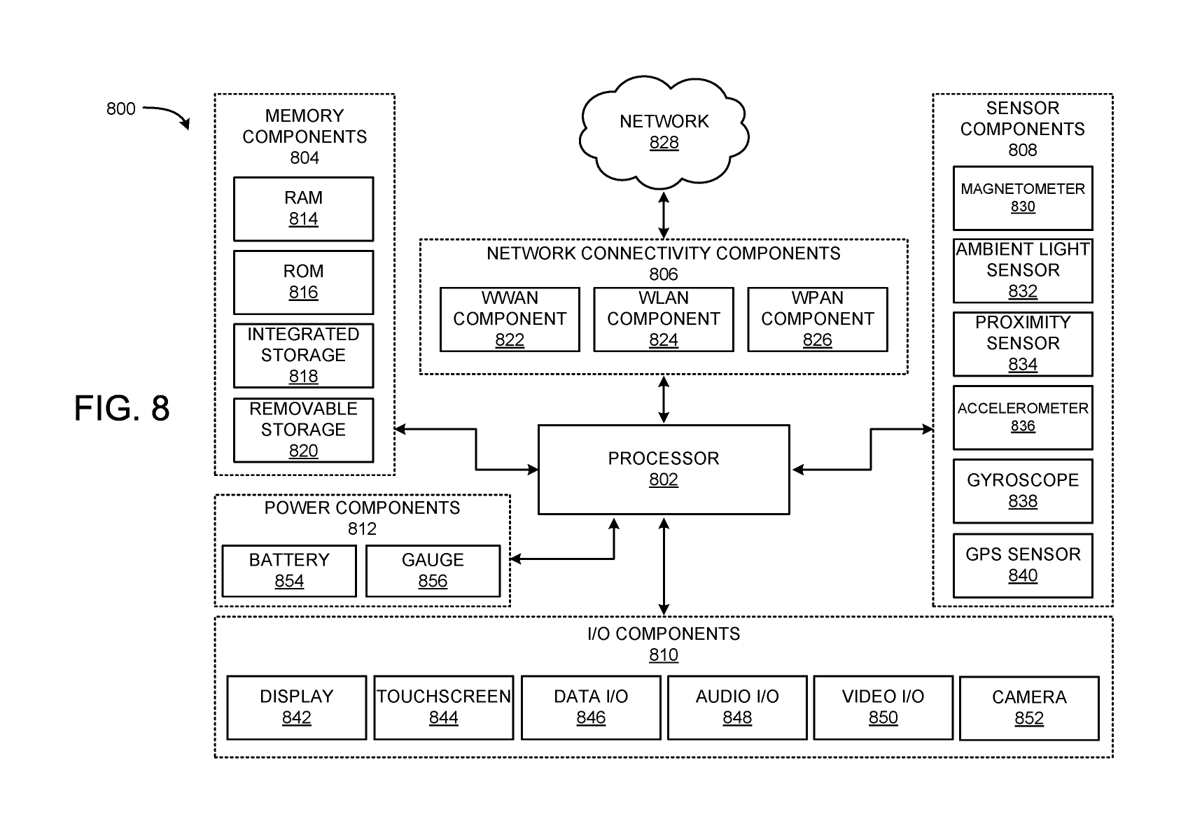

In order to provide this and the other functionality disclosed herein, the head mounted augmented reality display device 500 can include one or more processing units and computer-readable media (not shown in FIG. 5) for executing the software components disclosed herein, including an operating system 118 and/or an application 120 configured to change aspects of the UI that they provide based upon the brain activity and gaze of a wearer of the head mounted augmented reality display device 500. Several illustrative hardware configurations for implementing the head mounted augmented reality display device 500 are provided below with regard to FIGS. 6 and 8.

FIG. 6 is a computer architecture diagram that shows an architecture for a computing device 600 capable of executing the software components described herein. The architecture illustrated in FIG. 6 can be utilized to implement the head mounted augmented reality display device 500 or a server computer, mobile phone, e-reader, smartphone, desktop computer, netbook computer, tablet or slate computer, laptop computer, game console, set top box, or another type of computing device suitable for executing the software components presented herein.

In this regard, it should be appreciated that the computing device 600 shown in FIG. 6 can be utilized to implement a computing device capable of executing any of the software components presented herein. For example, and without limitation, the computing architecture described with reference to the computing device 600 can be utilized to implement the head mounted augmented reality display device 500 and/or to implement other types of computing devices for executing any of the other software components described above. Other types of hardware configurations, including custom integrated circuits and systems-on-a-chip (“SoCs”) can also be utilized to implement the head mounted augmented reality display device 500.

The computing device 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computing device 600, such as during startup, is stored in the ROM 608. The computing device 600 further includes a mass storage device 612 for storing an operating system 614 and one or more programs including, but not limited to the operating system 118, the application 120, the machine learning classifier 112, and the API 116. The mass storage device 612 can also be configured to store other types of programs and data described herein but not specifically shown in FIG. 6.

The mass storage device 612 is connected to the CPU 602 through a mass storage controller (not shown) connected to the bus 610. The mass storage device 612 and its associated computer readable media provide non-volatile storage for the computing device 600. Although the description of computer readable media contained herein refers to a mass storage device, such as a hard disk, CD-ROM drive, DVD-ROM drive, or universal storage bus (“USB”) storage key, it should be appreciated by those skilled in the art that computer readable media can be any available computer storage media or communication media that can be accessed by the computing device 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid state memory devices, CD-ROM, digital versatile disks (“DVD”), HD-DVD, BLU-RAY, or other optical storage disks, magnetic cassettes, magnetic tape, magnetic disk storage or other magnetic storage devices, or any other medium that can be used to store the desired information and which can be accessed by the computing device 600. For purposes of the claims, the phrase “computer storage medium,” and variations thereof, does not include waves or signals per se or communication media.

According to various configurations, the computing device 600 can operate in a networked environment using logical connections to remote computers through a network, such as the network 618. The computing device 600 can connect to the network 618 through a network interface unit 620 connected to the bus 610. It should be appreciated that the network interface unit 620 can also be utilized to connect to other types of networks and remote computer systems. The computing device 600 can also include an input/output controller 616 for receiving and processing input from a number of other devices, including the brain activity sensors 104, the biosensors 106, the gaze sensors 107, a keyboard, mouse, touch input, or electronic stylus (not all of which are shown in FIG. 6). Similarly, the input/output controller 616 can provide output to a display screen (such as the display 504 or the display device 126), a printer, or other type of output device (not all of which are shown in FIG. 6).

It should be appreciated that the software components described herein, such as, but not limited to, the machine learning classifier 112 and the API 116, can, when loaded into the CPU 602 and executed, transform the CPU 602 and the overall computing device 600 from a general-purpose computing device into a special-purpose computing device customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software modules disclosed herein, such as but not limited to the machine learning classifier 112, the machine learning engine 200, the API 116, the application 120, and the operating system 118. These computer-executable instructions can transform the CPU 602 by specifying how the CPU 602 transitions between states, thereby transforming the transistors or other discrete hardware elements constituting the CPU 602.

Encoding the software components presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software components presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computing device 600 in order to store and execute the software components presented herein. It should also be appreciated that the architecture shown in FIG. 6 for the computing device 600, or a similar architecture, can be utilized to implement other types of computing devices, including hand-held computers, wearable computing devices, VR computing devices, embedded computer systems, mobile devices such as smartphones and tablets, and other types of computing devices known to those skilled in the art. It is also contemplated that the computing device 600 might not include all of the components shown in FIG. 6, can include other components that are not explicitly shown in FIG. 6, or can utilize an architecture completely different than that shown in FIG. 6.

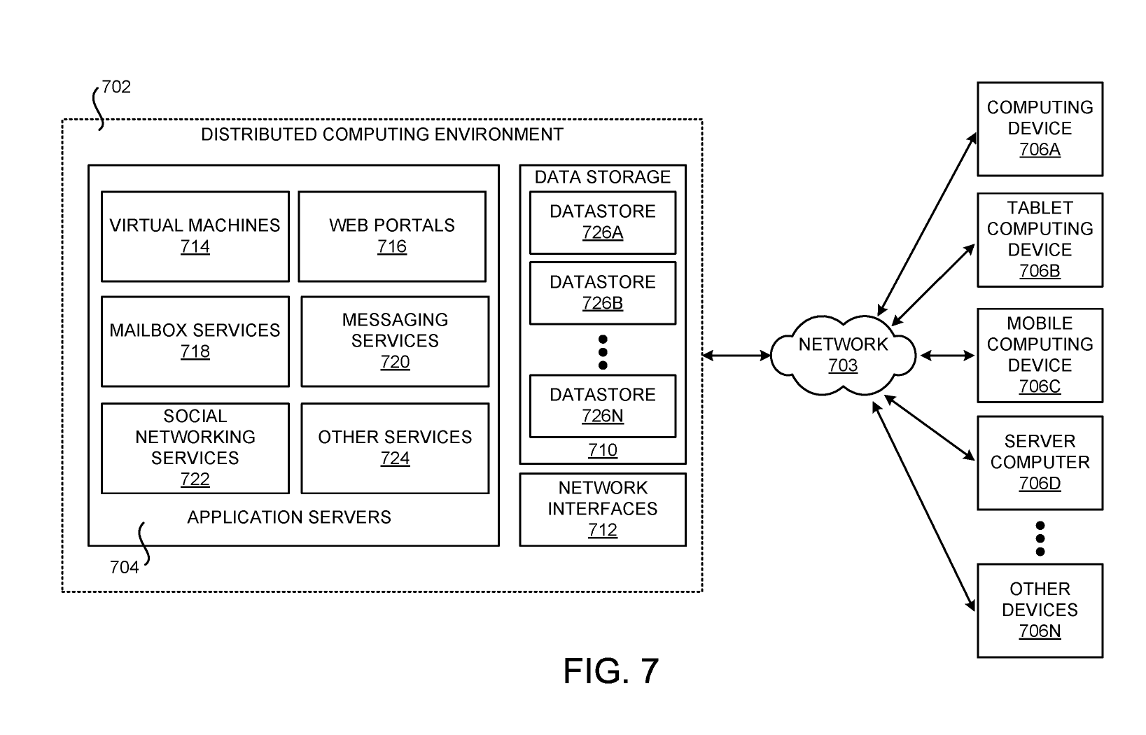

FIG. 7 shows aspects of an illustrative distributed computing environment 702 that can be utilized in conjunction with the technologies disclosed herein for modifying the operation of a computing device based upon a user's brain activity and gaze. According to various implementations, the distributed computing environment 702 operates on, in communication with, or as part of a network 703. One or more client devices 706A-706N (hereinafter referred to collectively and/or generically as “clients 706”) can communicate with the distributed computing environment 702 via the network 703 and/or other connections (not illustrated in FIG. 7).

In the illustrated configuration, the clients 706 include: a computing device 706A such as a laptop computer, a desktop computer, or other computing device; a “slate” or tablet computing device (“tablet computing device”) 706B; a mobile computing device 706C such as a mobile telephone, a smart phone, or other mobile computing device; a server computer 706D; and/or other devices 706N, such as the head mounted augmented reality display device 500 or a head mounted VR device.

It should be understood that virtually any number of clients 706 can communicate with the distributed computing environment 702. Two example computing architectures for the clients 706 are illustrated and described herein with reference to FIGS. 6 and 8. In this regard it should be understood that the illustrated clients 706 and computing architectures illustrated and described herein are illustrative, and should not be construed as being limiting in any way.

In the illustrated configuration, the distributed computing environment 702 includes application servers 704, data storage 710, and one or more network interfaces 712. According to various implementations, the functionality of the application servers 704 can be provided by one or more server computers that are executing as part of, or in communication with, the network 703. The application servers 704 can host various services, virtual machines, portals, and/or other resources. In the illustrated configuration, the application servers 704 host one or more virtual machines 714 for hosting applications, network services, or other types of applications and/or services. It should be understood that this configuration is illustrative, and should not be construed as being limiting in any way. The application servers 704 might also host or provide access to one or more web portals, link pages, web sites, and/or other information (“web portals”) 716.

According to various implementations, the application servers 704 also include one or more mailbox services 718 and one or more messaging services 720. The mailbox services 718 can include electronic mail (“email”) services. The mailbox services 718 can also include various personal information management (“PIM”) services including, but not limited to, calendar services, contact management services, collaboration services, and/or other services. The messaging services 720 can include, but are not limited to, instant messaging (“IM”) services, chat services, forum services, and/or other communication services.

The application servers 704 can also include one or more social networking services 722. The social networking services 722 can provide various types of social networking services including, but not limited to, services for sharing or posting status updates, instant messages, links, photos, videos, and/or other information, services for commenting or displaying interest in articles, products, blogs, or other resources, and/or other services. In some configurations, the social networking services 722 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 722 are provided by other services, sites, and/or providers that might be referred to as “social networking providers.” For example, some web sites allow users to interact with one another via email, chat services, and/or other means during various activities and/or contexts such as reading published articles, commenting on goods or services, publishing, collaboration, gaming, and the like. Other services are possible and are contemplated.

The social networking services 722 can also include commenting, blogging, and/or microblogging services. Examples of such services include, but are not limited to, the YELP commenting service, the KUDZU review service, the OFFICETALK enterprise microblogging service, the TWITTER messaging service, and/or other services. It should be appreciated that the above lists of services are not exhaustive and that numerous additional and/or alternative social networking services 722 are not mentioned herein for the sake of brevity. As such, the configurations described above are illustrative, and should not be construed as being limited in any way.

As also shown in FIG. 7, the application servers 704 can also host other services, applications, portals, and/or other resources (“other services”) 724. The other services 724 can include, but are not limited to, any of the other software components described herein. It thus can be appreciated that the distributed computing environment 702 can provide integration of the technologies disclosed herein with various mailbox, messaging, blogging, social networking, productivity, and/or other types of services or resources. For example, and without limitation, the technologies disclosed herein can be utilized to modify a UI presented by the network services shown in FIG. 7 based upon the brain activity and gaze of a user. In order to provide this functionality, the API 116 can expose the UI state 114 to the various network services. The network services, in turn, can modify aspects of their operation based upon the user's brain activity and gaze. The technologies disclosed herein can also be integrated with the network services shown in FIG. in other ways in other configurations.

As mentioned above, the distributed computing environment 702 can include data storage 710. According to various implementations, the functionality of the data storage 710 is provided by one or more databases operating on, or in communication with, the network 703. The functionality of the data storage 710 can also be provided by one or more server computers configured to host data for the distributed computing environment 702. The data storage 710 can include, host, or provide one or more real or virtual datastores 726A-726N (hereinafter referred to collectively and/or generically as “datastores 726”). The datastores 726 are configured to host data used or created by the application servers 704 and/or other data.

The distributed computing environment 702 can communicate with, or be accessed by, the network interfaces 712. The network interfaces 712 can include various types of network hardware and software for supporting communications between two or more computing devices including, but not limited to, the clients 706 and the application servers 704. It should be appreciated that the network interfaces 712 can also be utilized to connect to other types of networks and/or computer systems.

It should be understood that the distributed computing environment 702 described herein can implement any aspects of the software elements described herein with any number of virtual computing resources and/or other distributed computing functionality that can be configured to execute any aspects of the software components disclosed herein. According to various implementations of the technologies disclosed herein, the distributed computing environment 702 provides some or all of the software functionality described herein as a service to the clients 706. For example, the distributed computing environment 702 can implement the machine learning engine 200 and/or the machine learning classifier 112.

It should be understood that the clients 706 can also include real or virtual machines including, but not limited to, server computers, web servers, personal computers, mobile computing devices, VR devices, wearable computing devices, smart phones, and/or other devices. As such, various implementations of the technologies disclosed herein enable any device configured to access the distributed computing environment 702 to utilize the functionality described herein.

Turning now to FIG. 8, an illustrative computing device architecture 800 will be described for a computing device that is capable of executing the various software components described herein. The computing device architecture 800 is applicable to computing devices that facilitate mobile computing due, in part, to form factor, wireless connectivity, and/or battery-powered operation. In some configurations, the computing devices include, but are not limited to, smart mobile telephones, tablet devices, slate devices, portable video game devices, or wearable computing devices such as VR devices and the head mounted augmented reality display device 500 shown in FIG. 5.

The computing device architecture 800 is also applicable to any of the clients 706 shown in FIG. 7. Furthermore, aspects of the computing device architecture 800 are applicable to traditional desktop computers, portable computers (e.g., laptops, notebooks, ultra-portables, and netbooks), server computers, smartphone, tablet or slate devices, and other computer systems, such as those described herein with reference to FIG. 7. For example, the single touch and multi-touch aspects disclosed herein below can be applied to desktop computers that utilize a touchscreen or some other touch-enabled device, such as a touch-enabled track pad or touch-enabled mouse. The computing device architecture 800 can also be utilized to implement the computing devices 108 and/or other types of computing devices for implementing or consuming the functionality described herein.

The computing device architecture 800 illustrated in FIG. 8 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812. Although no connections are shown between the individual components illustrated in FIG. 8, the components can be connected electrically in order to interact and carry out device functions. In some configurations, the components are arranged so as to communicate via one or more busses (not shown).

The processor 802 includes one or more CPU cores configured to process data, execute computer-executable instructions of one or more programs, such as the machine learning classifier 112 and the API 116, and to communicate with other components of the computing device architecture 800 in order to perform aspects of the functionality described herein. The processor 802 can be utilized to execute aspects of the software components presented herein and, particularly, those that utilize, at least in part, a touch-enabled or non-touch gesture-based input.

In some configurations, the processor 802 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, 4K, and greater), video games, 3D modeling applications, and the like. In some configurations, the processor 802 is configured to communicate with a discrete GPU (not shown). In any case, the CPU and GPU can be configured in accordance with a co-processing CPU/GPU computing model, wherein the sequential part of an application executes on the CPU and the computationally intensive part is accelerated by the GPU.

In some configurations, the processor 802 is, or is included in, a SoC along with one or more of the other components described herein below. For example, the SoC can include the processor 802, a GPU, one or more of the network connectivity components 806, and one or more of the sensor components 808. In some configurations, the processor 802 is fabricated, in part, utilizing a package-on-package (“PoP”) integrated circuit packaging technique. Moreover, the processor 802 can be a single core or multi-core processor.

The processor 802 can be created in accordance with an ARM architecture, available for license from ARM HOLDINGS of Cambridge, United Kingdom. Alternatively, the processor 802 can be created in accordance with an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a RAM 814, a ROM 816, an integrated storage memory (“integrated storage”) 818, and a removable storage memory (“removable storage”) 820. In some configurations, the RAM 814 or a portion thereof, the ROM 816 or a portion thereof, and/or some combination of the RAM 814 and the ROM 816 is integrated in the processor 802. In some configurations, the ROM 816 is configured to store a firmware, an operating system 118 or a portion thereof (e.g., operating system kernel), and/or a bootloader to load an operating system kernel from the integrated storage 818 or the removable storage 820.

The integrated storage 818 can include a solid-state memory, a hard disk, or a combination of solid-state memory and a hard disk. The integrated storage 818 can be soldered or otherwise connected to a logic board upon which the processor 802 and other components described herein might also be connected. As such, the integrated storage 818 is integrated into the computing device. The integrated storage 818 can be configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available and shown to a user as a total combined capacity of the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 can be embodied in various memory card formats including, but not limited to, PC card, COMPACTFLASH card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system. According to various configurations, the operating system includes, but is not limited to, the WINDOWS MOBILE OS, the WINDOWS PHONE OS, or the WINDOWS OS from MICROSOFT CORPORATION, BLACKBERRY OS from RESEARCH IN MOTION, LTD. of Waterloo, Ontario, Canada, IOS from APPLE INC. of Cupertino, Calif., and ANDROID OS from GOOGLE, INC. of Mountain View, Calif. Other operating systems can also be utilized.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from a network 828, which can be a WWAN, a WLAN, or a WPAN. Although a single network 828 is illustrated, the network connectivity components 806 can facilitate simultaneous communication with multiple networks. For example, the network connectivity components 806 can facilitate simultaneous communications with multiple networks via one or more of a WWAN, a WLAN, or a WPAN.

The network 828 can be a WWAN, such as a mobile telecommunications network utilizing one or more mobile telecommunications technologies to provide voice and/or data services to a computing device utilizing the computing device architecture 800 via the WWAN component 822. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”).

Moreover, the network 828 can utilize various channel access methods (which might or might not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications can be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 828 can be configured to provide voice and/or data communications with any combination of the above technologies. The network 828 can be configured or adapted to provide voice and/or data communications in accordance with future generation technologies.

In some configurations, the WWAN component 822 is configured to provide dual- multi-mode connectivity to the network 828. For example, the WWAN component 822 can be configured to provide connectivity to the network 828, wherein the network 828 provides service via GSM and UMTS technologies, or via some other combination of technologies. Alternatively, multiple WWAN components 822 can be utilized to perform such functionality, and/or provide additional functionality to support other non-compatible technologies (i.e., incapable of being supported by a single WWAN component). The WWAN component 822 can facilitate similar connectivity to multiple networks (e.g., a UMTS network and an LTE network).

The network 828 can be a WLAN operating in accordance with one or more Institute of Electrical and Electronic Engineers (“IEEE”) 104.11 standards, such as IEEE 104.11a, 104.11b, 104.11g, 104.11n , and/or a future 104.11 standard (referred to herein collectively as WI-FI). Draft 104.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 828 via the WI-FI access points. Such connections can be secured via various encryption technologies including, but not limited, WI-FI Protected Access (“WPA”), WPA2, Wired Equivalent Privacy (“WEP”), and the like.

The network 828 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing devices via the WPAN.

The sensor components 808 include a magnetometer 830, an ambient light sensor 832, a proximity sensor 834, an accelerometer 836, a gyroscope 838, and a Global Positioning System sensor (“GPS sensor”) 840. It is contemplated that other sensors, such as, but not limited to, the sensors 502A and 502B, the brain activity sensors 104, the gaze sensors 107, the biosensors 108, temperature sensors or shock detection sensors, might also be incorporated in the computing device architecture 800.

The magnetometer 830 is configured to measure the strength and direction of a magnetic field. In some configurations the magnetometer 830 provides measurements to a compass application program stored within one of the memory components 804 in order to provide a user with accurate directions in a frame of reference including the cardinal directions, north, south, east, and west. Similar measurements can be provided to a navigation application program that includes a compass component. Other uses of measurements obtained by the magnetometer 830 are contemplated.

The ambient light sensor 832 is configured to measure ambient light. In some configurations, the ambient light sensor 832 provides measurements to an application program stored within one of the memory components 804 in order to automatically adjust the brightness of a display (described below) to compensate for low light and bright light environments. Other uses of measurements obtained by the ambient light sensor 832 are contemplated.

The proximity sensor 834 is configured to detect the presence of an object or thing in proximity to the computing device without direct contact. In some configurations, the proximity sensor 834 detects the presence of a user's body (e.g., the user's face) and provides this information to an application program stored within one of the memory components 804 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 834 are contemplated.

The accelerometer 836 is configured to measure acceleration. In some configurations, output from the accelerometer 836 is used by an application program as an input mechanism to control some functionality of the application program. In some configurations, output from the accelerometer 836 is provided to an application program for use in switching between landscape and portrait modes, calculating coordinate acceleration, or detecting a fall. Other uses of the accelerometer 836 are contemplated.

The gyroscope 838 is configured to measure and maintain orientation. In some configurations, output from the gyroscope 838 is used by an application program as an input mechanism to control some functionality of the application program. For example, the gyroscope 838 can be used for accurate recognition of movement within a 3D environment of a video game application or some other application. In some configurations, an application program utilizes output from the gyroscope 838 and the accelerometer 836 to enhance control of some functionality. Other uses of the gyroscope 838 are contemplated.

The GPS sensor 840 is configured to receive signals from GPS satellites for use in calculating a location. The location calculated by the GPS sensor 840 can be used by any application program that requires or benefits from location information. For example, the location calculated by the GPS sensor 840 can be used with a navigation application program to provide directions from the location to a destination or directions from the destination to the location. Moreover, the GPS sensor 840 can be used to provide location information to an external location-based service, such as E911 service. The GPS sensor 840 can obtain location information generated via WI-FI, WIMAX, and/or cellular triangulation techniques utilizing one or more of the network connectivity components 806 to aid the GPS sensor 840 in obtaining a location fix. The GPS sensor 840 can also be used in Assisted GPS (“A-GPS”) systems.

The I/O components 810 include a display 842, a touchscreen 844, a data I/O interface component (“data I/O”) 846, an audio I/O interface component (“audio I/O”) 848, a video I/O interface component (“video I/O”) 850, and a camera 852. In some configurations, the display 842 and the touchscreen 844 are combined. In some configurations two or more of the data I/O component 846, the audio I/O component 848, and the video I/O component 850 are combined. The I/O components 810 can include discrete processors configured to support the various interfaces described below, or might include processing functionality built-in to the processor 802.

The display 842 is an output device configured to present information in a visual form. In particular, the display 842 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 842 is a liquid crystal display (“LCD”) utilizing any active or passive matrix technology and any backlighting technology (if used). In some configurations, the display 842 is an organic light emitting diode (“OLED”) display. Other display types are contemplated such as, but not limited to, the transparent displays discussed above with regard to FIG. 5.

The touchscreen 844 is an input device configured to detect the presence and location of a touch. The touchscreen 844 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen 844 is incorporated on top of the display 842 as a transparent layer to enable a user to use one or more touches to interact with objects or other information presented on the display 842. In other configurations, the touchscreen 844 is a touch pad incorporated on a surface of the computing device that does not include the display 842. For example, the computing device can have a touchscreen incorporated on top of the display 842 and a touch pad on a surface opposite the display 842.

In some configurations, the touchscreen 844 is a single-touch touchscreen. In other configurations, the touchscreen 844 is a multi-touch touchscreen. In some configurations, the touchscreen 844 is configured to detect discrete touches, single touch gestures, and/or multi-touch gestures. These are collectively referred to herein as “gestures” for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 844. As such, a developer can create gestures that are specific to a particular application program.

In some configurations, the touchscreen 844 supports a tap gesture in which a user taps the touchscreen 844 once on an item presented on the display 842. The tap gesture can be used for various reasons including, but not limited to, opening or launching whatever the user taps, such as a graphical icon representing the collaborative authoring application 110. In some configurations, the touchscreen 844 supports a double tap gesture in which a user taps the touchscreen 844 twice on an item presented on the display 842. The double tap gesture can be used for various reasons including, but not limited to, zooming in or zooming out in stages. In some configurations, the touchscreen 844 supports a tap and hold gesture in which a user taps the touchscreen 844 and maintains contact for at least a pre-defined time. The tap and hold gesture can be used for various reasons including, but not limited to, opening a context-specific menu.

In some configurations, the touchscreen 844 supports a pan gesture in which a user places a finger on the touchscreen 844 and maintains contact with the touchscreen 844 while moving the finger on the touchscreen 844. The pan gesture can be used for various reasons including, but not limited to, moving through screens, images, or menus at a controlled rate. Multiple finger pan gestures are also contemplated. In some configurations, the touchscreen 844 supports a flick gesture in which a user swipes a finger in the direction the user wants the screen to move. The flick gesture can be used for various reasons including, but not limited to, scrolling horizontally or vertically through menus or pages. In some configurations, the touchscreen 844 supports a pinch and stretch gesture in which a user makes a pinching motion with two fingers (e.g., thumb and forefinger) on the touchscreen 844 or moves the two fingers apart. The pinch and stretch gesture can be used for various reasons including, but not limited to, zooming gradually in or out of a website, map, or picture.

Although the gestures described above have been presented with reference to the use of one or more fingers for performing the gestures, other appendages such as toes or objects such as styluses can be used to interact with the touchscreen 844. As such, the above gestures should be understood as being illustrative and should not be construed as being limiting in any way.

The data I/O interface component 846 is configured to facilitate input of data to the computing device and output of data from the computing device. In some configurations, the data I/O interface component 846 includes a connector configured to provide wired connectivity between the computing device and a computer system, for example, for synchronization operation purposes. The connector can be a proprietary connector or a standardized connector such as USB, micro-USB, mini-USB, USB-C, or the like. In some configurations, the connector is a dock connector for docking the computing device with another device such as a docking station, audio device (e.g., a digital music player), or video device.

The audio I/O interface component 848 is configured to provide audio input and/or output capabilities to the computing device. In some configurations, the audio I/O interface component 846 includes a microphone configured to collect audio signals. In some configurations, the audio I/O interface component 848 includes a headphone jack configured to provide connectivity for headphones or other external speakers. In some configurations, the audio interface component 848 includes a speaker for the output of audio signals. In some configurations, the audio I/O interface component 848 includes an optical audio cable out.

The video I/O interface component 850 is configured to provide video input and/or output capabilities to the computing device. In some configurations, the video I/O interface component 850 includes a video connector configured to receive video as input from another device (e.g., a video media player such as a DVD or BLU-RAY player) or send video as output to another device (e.g., a monitor, a television, or some other external display). In some configurations, the video I/O interface component 850 includes a High-Definition Multimedia Interface (“HDMI”), mini-HDMI, micro-HDMI, DISPLAYPORT, or proprietary connector to input/output video content. In some configurations, the video I/O interface component 850 or portions thereof is combined with the audio I/O interface component 848 or portions thereof

The camera 852 can be configured to capture still images and/or video. The camera 852 can utilize a charge coupled device (“CCD”) or a complementary metal oxide semiconductor (“CMOS”) image sensor to capture images. In some configurations, the camera 852 includes a flash to aid in taking pictures in low-light environments. Settings for the camera 852 can be implemented as hardware or software buttons.

Although not illustrated, one or more hardware buttons can also be included in the computing device architecture 800. The hardware buttons can be used for controlling some operational aspect of the computing device. The hardware buttons can be dedicated buttons or multi-use buttons. The hardware buttons can be mechanical or sensor-based.

The illustrated power components 812 include one or more batteries 854, which can be connected to a battery gauge 856. The batteries 854 can be rechargeable or disposable. Rechargeable battery types include, but are not limited to, lithium polymer, lithium ion, nickel cadmium, and nickel metal hydride. Each of the batteries 854 can be made of one or more cells.

The battery gauge 856 can be configured to measure battery parameters such as current, voltage, and temperature. In some configurations, the battery gauge 856 is configured to measure the effect of a battery's discharge rate, temperature, age and other factors to predict remaining life within a certain percentage of error. In some configurations, the battery gauge 856 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 812 can also include a power connector (not shown), which can be combined with one or more of the aforementioned I/O components 810. The power components 812 can interface with an external power system or charging equipment via a power I/O component. Other configurations can also be utilized.

In view of the above, it is to be appreciated that the disclosure presented herein also encompasses the subject matter set forth in the following clauses:

Clause 1: A computer-implemented method, comprising: training a machine learning model using data identifying a first user interface (UI) state for a UI provided by a computing device, data identifying first brain activity of a user of the computing device, and data identifying a first location of a gaze of the user; receiving data identifying second brain activity of the user and data identifying a second location of a gaze of the user while operating the computing device; utilizing the machine learning model, the data identifying the second brain activity of the user, and the data identifying the second location of the gaze of the user to select a second UI state for the UI provided by the computing device; and causing the UI provided by the computing device to operate in accordance with the selected second UI state.

Clause 2: The computer-implemented method of clause 1, further comprising exposing data identifying the selected second UI state by way of an application programming interface (API).

Clause 3: The computer-implemented method of clauses 1 and 2, wherein causing the UI provided by the computing device to operate in accordance with the selected second UI state comprises modifying a size of one or more UI objects in the UI provided by the computing device.

Clause 4: The computer-implemented method of clauses 1-3, wherein causing the UI provided by the computing device to operate in accordance with the selected second UI state comprises modifying a focus of one or more UI objects in the UI provided by the computing device.

Clause 5: The computer-implemented method of clauses 1-4, wherein causing the UI provided by the computing device to operate in accordance with the selected second UI state comprises modifying a layout of one or more UI objects in the UI provided by the computing device.

Clause 6: The computer-implemented method of clauses 1-5, wherein causing the UI provided by the computing device to operate in accordance with the selected second UI state comprises modifying a location of one or more UI objects in the UI provided by the computing device.

Clause 7. The computer-implemented method of clauses 1-6, wherein causing the UI provided by the computing device to operate in accordance with the selected second UI state comprises modifying a number of UI objects in the UI provided by the computing device.

Clause 8: The computer-implemented method of clauses 1-7, wherein causing the UI provided by the computing device to operate in accordance with the selected second UI state comprises modifying an ordering of UI objects in the UI provided by the computing device.

Clause 9: The computer-implemented method of clauses 1-8, wherein causing the UI provided by the computing device to operate in accordance with the selected second UI state comprises causing a UI object in the UI provided by the computing device to be presented in a full screen mode of operation.

Clause 10: An apparatus, comprising: one or more processors; and at least one computer storage medium having computer executable instructions stored thereon which, when executed by the one or more processors, cause the apparatus to expose an application programming interface (API) for providing data identifying a state for a user interface (UI) presented by the apparatus, receive a request at the API, utilize a machine learning model to select one of a plurality of UI states for the UI, the one of the plurality of UI states being selected based, at least in part, upon data identifying brain activity of a user of the apparatus and data identifying a location of a gaze of the user of the apparatus, and provide data identifying the selected one of the plurality of UI states for the UI responsive to the request.

Clause 11: The apparatus of clause 10, wherein the at least one computer storage medium has further computer executable instructions stored thereon to cause the UI presented by the apparatus to operate in accordance with the selected one of the plurality of UI states.

Clause 12: The apparatus of clauses 10-11, wherein cause the UI presented by the apparatus to operate in accordance with the selected one of the plurality of UI states comprises modifying a size of one or more UI objects in the UI presented by the apparatus.

Clause 13: The apparatus of clauses 10-12, wherein cause the UI presented by the apparatus to operate in accordance with the selected one of the plurality of UI states comprises modifying a focus of one or more UI objects in the UI presented by the apparatus.

Clause 14: The apparatus of clauses 10-13, wherein cause the UI presented by the apparatus to operate in accordance with the selected one of the plurality of UI states comprises modifying a number of UI objects in the UI presented by the apparatus.

Clause 15: The apparatus of clauses 10-14, wherein cause the UI presented by the apparatus to operate in accordance with the selected one of the plurality of UI states comprises causing a UI object in the UI presented by the apparatus to be presented in a full screen mode of operation.

Clause 16: A computer storage medium having computer executable instructions stored thereon which, when executed by one or more processors, cause the processors to: receive data identifying first brain activity of a user of a computing device and first data identifying a location of a gaze of the user while operating the computing device; select a state for a UI provided by the computing device based, at least in part, upon the data identifying the first brain activity of the user and the first data identifying the location of the gaze of the user while operating the computing device; and cause the UI provided by the computing device to operate in accordance with the selected UI state.

Clause 17: The computer storage medium of clause 16, having further computer executable instructions stored thereon to expose data identifying the selected UI state by way of an application programming interface (API).

Clause 18: The computer storage medium of clauses 16-17, wherein the state for the UI provided by the computing device is selected utilizing a machine learning model trained using data identifying second brain activity of the user of the computing device and data identifying a second location of a gaze of the user.

Clause 19: The computer storage medium of clauses 16-18, wherein cause the UI provided by the computing device to operate in accordance with the selected UI state comprises modifying a focus of one or more UI objects in the UI provided by the computing device.

Clause 20: The computer storage medium of 16-19, wherein cause the UI provided by the computing device to operate in accordance with the selected UI state comprises modifying a size of one or more UI objects in the UI provided by the computing device.

Based on the foregoing, it should be appreciated that various technologies for modifying the state of a UI based upon a user's brain activity and gaze have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
training a machine learning model using data identifying a first user interface (UI) state for a UI provided by a computing device, data identifying first brain activity of a user of the computing device, and data identifying a first location of a gaze of the user;
receiving data identifying second brain activity of the user and data identifying a second location of a gaze of the user while operating the computing device;
utilizing the machine learning model, the data identifying the second brain activity of the user, and the data identifying the second location of the gaze of the user to select a second UI state for the UI provided by the computing device; and
causing the UI provided by the computing device to operate in accordance with the selected second UI state.

2. The computer-implemented method of claim 1, further comprising exposing data identifying the selected second UI state by way of an application programming interface (API).

3. The computer-implemented method of claim 1, wherein causing the UI provided by the computing device to operate in accordance with the selected second UI state comprises modifying a size of one or more UI objects in the UI provided by the computing device.

4. The computer-implemented method of claim 1, wherein causing the UI provided by the computing device to operate in accordance with the selected second UI state comprises modifying a focus of one or more UI objects in the UI provided by the computing device.

5. The computer-implemented method of claim 1, wherein causing the UI provided by the computing device to operate in accordance with the selected second UI state comprises modifying a layout of one or more UI objects in the UI provided by the computing device.

6. The computer-implemented method of claim 1, wherein causing the UI provided by the computing device to operate in accordance with the selected second UI state comprises modifying a location of one or more UI objects in the UI provided by the computing device.

7. The computer-implemented method of claim 1, wherein causing the UI provided by the computing device to operate in accordance with the selected second UI state comprises modifying a number of UI objects in the UI provided by the computing device.

8. The computer-implemented method of claim 1, wherein causing the UI provided by the computing device to operate in accordance with the selected second UI state comprises modifying an ordering of UI objects in the UI provided by the computing device.

9. The computer-implemented method of claim 1, wherein causing the UI provided by the computing device to operate in accordance with the selected second UI state comprises causing a UI object in the UI provided by the computing device to be presented in a full screen mode of operation.

10. An apparatus, comprising:
one or more processors; and
at least one computer storage medium having computer executable instructions stored thereon which, when executed by the one or more processors, cause the apparatus to
expose an application programming interface (API) for providing data identifying a state for a user interface (UI) presented by the apparatus,
receive a request at the API,
utilize a machine learning model to select one of a plurality of UI states for the UI, the one of the plurality of UI states being selected based, at least in part, upon data identifying brain activity of a user of the apparatus and data identifying a location of a gaze of the user of the apparatus, and
provide data identifying the selected one of the plurality of UI states for the UI responsive to the request.

11. The apparatus of claim 10, wherein the at least one computer storage medium has further computer executable instructions stored thereon to cause the UI presented by the apparatus to operate in accordance with the selected one of the plurality of UI states.

12. The apparatus of claim 11, wherein cause the UI presented by the apparatus to operate in accordance with the selected one of the plurality of UI states comprises modifying a size of one or more UI objects in the UI presented by the apparatus.

13. The apparatus of claim 11, wherein cause the UI presented by the apparatus to operate in accordance with the selected one of the plurality of UI states comprises modifying a focus of one or more UI objects in the UI presented by the apparatus.

14. The apparatus of claim 11, wherein cause the UI presented by the apparatus to operate in accordance with the selected one of the plurality of UI states comprises modifying a number of UI objects in the UI presented by the apparatus.

15. The apparatus of claim 11, wherein cause the UI presented by the apparatus to operate in accordance with the selected one of the plurality of UI states comprises causing a UI object in the UI presented by the apparatus to be presented in a full screen mode of operation.

16. A computer storage medium having computer executable instructions stored thereon which, when executed by one or more processors, cause the processors to:
receive data identifying first brain activity of a user of a computing device and first data identifying a location of a gaze of the user while operating the computing device;
select a state for a UI provided by the computing device based, at least in part, upon the data identifying the first brain activity of the user and the first data identifying the location of the gaze of the user while operating the computing device; and
cause the UI provided by the computing device to operate in accordance with the selected UI state.

17. The computer storage medium of claim 16, having further computer executable instructions stored thereon to expose data identifying the selected UI state by way of an application programming interface (API).

18. The computer storage medium of claim 16, wherein the state for the UI provided by the computing device is selected utilizing a machine learning model trained using data identifying second brain activity of the user of the computing device and data identifying a second location of a gaze of the user.

19. The computer storage medium of claim 16, wherein cause the UI provided by the computing device to operate in accordance with the selected UI state comprises modifying a focus of one or more UI objects in the UI provided by the computing device.

20. The computer storage medium of claim 16, wherein cause the UI provided by the computing device to operate in accordance with the selected UI state comprises modifying a size of one or more UI objects in the UI provided by the computing device.
